(19) United States
(12) Patent Application Publication
(10) Pub. No.: US 2026/0213099 A1
(43) Pub. Date: Jul. 23, 2026

(54) A CASSETTE CASING UNIT OF A MOULDED CASE CIRCUIT BREAKER (MCCB)

(71) Applicant: HAVELLS INDIA LIMITED, New Delhi (IN)

(72) Inventors: Sandeep Dalmia, Noida (IN); Umashankar Shanmugaraj, Noida (IN); Amrit Singh, Noida (IN); Gaurav Kumar, Noida (IN); Deepesh Gupta, Noida (IN); Nitin Rawal, Noida (IN); Sapandeep Singh, Noida (IN); Narayanan Janakiraman, Noida (IN); Pardeep Kumar, Noida (IN); Ankit Goyal, Noida (IN)

(73) Assignee: HAVELLS INDIA LIMITED, New Delhi, DL (IN)

(21) Appl. No.: 19/137,922

(22) PCT Filed: Dec. 10, 2023
(86) PCT No.: PCT/IN2023/051158

§ 371 Date: Jun. 11, 2025

(30) Foreign Application Priority Data
Dec. 12, 2022 (IN) 202211071711

(51) Int. Cl. H01H 33/08; H01H 33/53

(52) U.S. Cl. CPC H01H 33/08; H01H 33/53

(57) ABSTRACT

Described herein is a cassette casing unit [116] of a moulded case circuit breaker (MCCB) [100], comprising a left cassette member [116a] and a right cassette member [116b]. A combination of the first and second cassette member [116a, 116b] defines: an arc chute unit holding portion [116d] defined proximal to a front side [116j], for positioning an arc chute unit [122]; a stationary contact unit holding portion [116e] defined below the arc chute unit holding portion [116d], for positioning a stationary contact unit [118]; a rotary contact unit holding portion [116f] defined adjacent to the arc chute unit holding portion [116d], for positioning a rotary contact unit [120]; and a trip assembly holding portion [116i] defined adjacent to the rotary contact unit holding portion [116f] and proximal to a rear side [116k], for positioning at least a section of a trip assembly [114] of the MCCB [100].

### FIELD OF INVENTION

The present disclosure relates to low voltage circuit breakers employed to protect electrical networks/circuits from over-load or short-circuit conditions, more particularly, the present disclosure relates to a cassette casing unit of a moulded case circuit breaker (MCCB).

### BACKGROUND OF THE INVENTION

This section is intended to provide information relating to the field of the invention and thus, any approach or functionality described below should not be assumed to be qualified as prior art merely by its inclusion in this section.

Circuit Breakers are electro-mechanical switching devices capable of making, carrying and breaking currents and are also known as over current protective devices. Under normal circuit conditions, a circuit breaker closes the electrical circuit, carries current for a specified time and breaks the electrical circuit under specified abnormal circuit conditions. These over current protective devices are also employed for current interruption. Accordingly, it is said that circuit breaker is an equipment which can open or close the circuit, under all conditions viz. no load, full load and fault conditions. Low voltage circuit breakers are commonly known to be deployed for low voltage applications, for example 1000 Volt or lower.

Various examples of low voltage circuit breakers are known, for example, a Miniature Circuit Breaker (MCB), a Moulded Case Circuit Breaker (MCCB), a Residual Current Circuit Breaker (RCCB), an Air Circuit Breaker (ACB), and the like. Notably, the MCB is used in applications of current rating under 125 Amperes and interrupting current rating of under 10 KA, while MCCB is used in applications of current rating up to 1600 Amperes usually and interrupting current in a range of 10 KA-150 KA. Accordingly, it is submitted that MCCB is used for relatively high current rating applications.

Moulded case circuit breaker (MCCB) is commonly a multipolar circuit breaker, which protects the electrical network/circuit and equipment from overloading or short-circuiting. Specifically, the MCCB is capable of operating between an ON position, an OFF position, and a TRIP position. Conventionally, the MCCB includes at least a base assembly, a mid-cover assembly, a fascia plate assembly, at least one pole assembly, a TRIP assembly, and an actuator assembly. In one embodiment, the MCCB is a three-pole unit comprising of three (3) pole assemblies. In such embodiments, the base assembly, a mid-cover assembly, a fascia plate assembly, in combination with each other, forms a housing to house and support the three pole assemblies therein. Further, the actuator assembly is mounted on at least one of the three (3) pole assemblies, while the TRIP assembly is mounted on at least one of the three (3) pole assemblies, such that the three (3) pole assemblies are connected and operated together between the ON position, the OFF position, and the TRIP position. Particularly, the actuator assembly includes a lever switch that can be manually adjusted, to operate the three (3) pole assemblies together between the ON position, the OFF position, and the TRIP position.

In light of the aforementioned, it is understood that each pole assembly operates between the ON position, the OFF position, and the TRIP position. Conventionally, each of the three pole assemblies includes a cassette casing unit, a rotary contact unit, a stationary contact unit, and an arc chute unit. The cassette casing unit is a left-right type casing which includes defined sections for positioning of each of the rotary contact unit, the stationary contact unit, and the arc chute unit, such that the cassette casing unit houses and supports each of these components therein. The stationary contact unit is a conducting plate positioned within the cassette casing unit, and mostly electrically connected to a line side of the electric circuit. The rotary contact unit is a rotary assembly that is rotatably positioned within the cassette casing unit, and generally electrically connected to a load side of the electric circuit. The rotary contact unit can be rotated in one direction to allow the rotary contact unit to contact with the stationary contact unit, and thus resulting in the ON position of the pole assembly, further, the rotary contact unit can be rotated in opposite direction to allow the rotary contact unit to release contact from the stationary contact unit, and thus resulting in the OFF position of the pole assembly.

Moreover, the rotary contact unit is a combination of a rotary member, a rotating arm member, a metal conducting plate electrically connected to the rotating arm member, and a toggling mechanism. The rotating arm member is connected to the rotary member, by way of the toggling mechanism. Notably, the rotary member, the rotating arm member, and the toggling mechanism, are rotated together, to adjust the pole assembly between the ON position and the OFF position. The toggling mechanism toggles the rotating arm member, to rotate in one direction, with respect to the rotating member, to adjust the pole assembly between the ON position and. Therefore, the rotary contact unit plays a vital role in determining the accuracy, speed, and effectiveness of adjustment of the pole assembly, between the ON position, the OFF position, and the TRIP position.

The conventionally known cassette casing units are known to be bulky and not compact. Further, the conventionally known cassette casing units lack a channel for disposing exhaust gases generated within the MCCB. This requires placement of another bulky vent provision next to the conventionally known cassette casing units such that the said bulky vent provision is fluidly connected with the conventionally known cassette casing unit to enable disposal of the exhaust gases generated within the MCCB. This would naturally increase assembly time, cost and complexity of the MCCB. Moreover, the conventionally known cassette casing units are structured in such a way that assembly time and complexity increases, which further increases the cost of the conventionally known cassette casing units.

Accordingly in light of the aforementioned drawbacks and several other limitations inherent in the existing art, there is a well felt need to provide a compact, improved and easy to assemble —cassette casing unit deployed in MCCB, used for keeping the electrical network/circuits safe. Further, there is a requirement of compact structure with lesser parts resulting in cost benefits and improved reliability, of the cassette casing unit of each of the at least one pole assembly deployed in the MCCB.

### SUMMARY OF THE PRESENT INVENTION

This section is intended to introduce certain objects of the disclosed method and system in a simplified form and is not intended to identify the key advantages or features of the present disclosure.

The present disclosure relates to a cassette casing unit of a moulded case circuit breaker (MCCB), wherein the cassette casing unit is adapted to house and support a stationary contact unit, a rotary contact unit, and an arc chute unit of a pole assembly of the MCCB. The cassette casing unit comprises a first cassette member and a second cassette member, wherein a combination of the first and second cassette members defines an arc chute unit holding portion for positioning the arc chute unit, a stationary contact unit holding portion for position the stationary contact unit, a rotary contact unit holding portion for positioning the rotary contact unit, and a trip assembly holding portion for positioning at least a section of the TRIP assembly therein. Notably, the arc chute unit holding portion is defined proximal to a front side of the cassette casing unit, the stationary contact unit holding portion is defined below the arc chute unit holding portion, the rotary contact unit holding portion is defined adjacent to the arc chute holding portion, and the trip assembly holding portion is defined adjacent to the rotary contact unit holding portion.

The present invention provides narrow, uniform, and compact cassette casing unit for molded case circuit breakers (MCCB) in compact footprint width. The invention provides the cassette casing unit which accommodates a rotary contact unit, stationary contact (parallel and inclined) unit, and arc chute unit. The pole enclosure have a sideways split, a concealed pivot point for positioning rotary contact assembly and have bean-shaped slot for rotation of drive-shaft pin for adjacent pole assembly coupling.

The cassette casing unit of the pole assembly has a cylindrical recess to accommodate a metal bushing inside which cylindrical protrusion or a cylindrical pivot pin of aforementioned rotary contact unit articulates. The metal bushing reduces the frictional loses and hence the torque transmission of mechanism to rotary contact unit is enhanced which increases the useful life and uniform contact pressure for single or multiple pole assembly.

The cassette casing unit of the pole enclosure assembly has a narrow and uniform width throughout the length across line and load side contact which provides complete protective outer shell/case of the MCCB. The cassette casing unit of the pole assembly has a provision for arc chute unit along with adequate space for accommodating ablative structural component, which helps in balancing gas pressure and interruption performance.

The cassette casing unit of the pole assembly has a protruding cantilever cantilever gas exhaust channel connecting the arc chamber that channels the gases all the way outside the breaker boundary which makes the short circuit gas velocity not impacting on the thin outer shells. The width of the cantilever gas exhaust channel is almost equal to the overall width of cassette assembly. The cantilever gas exhaust channel also has provision for a cylinder shaped vent barrier acting as vent exhaust and same cylinder provides access for termination fastening as well.

### BRIEF DESCRIPTION OF THE INVENTION

In order to explain the technical solution in the embodiments of the present application more clearly, the drawings used in the description of the embodiments will be briefly introduced below. It is obvious that the drawings in the following description are only some embodiments of the application. For those ordinarily skilled in the art, without any creative work, other drawings can be obtained based on these drawings.

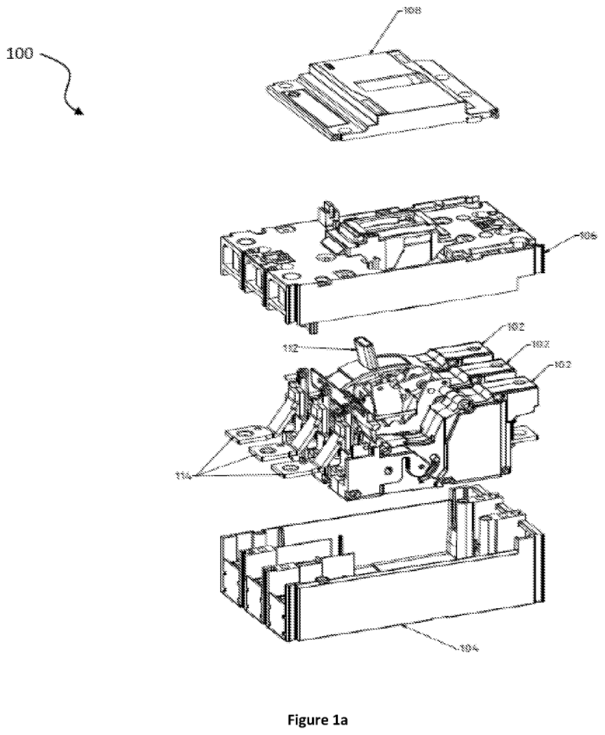

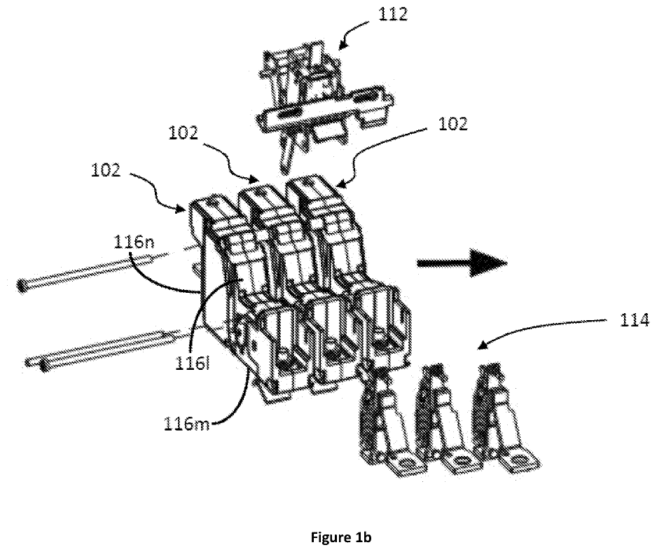

FIG. 1a shows an exploded view of a moulded case circuit breaker (MCCB), in accordance with the concepts of the present disclosure.

FIG. 1b shows an exploded view of an arrangement between the three pole assemblies, the actuator assembly, and the TRIP assembly of the moulded case circuit breaker (MCCB) of FIG. 1a, in accordance with the concepts of the present disclosure.

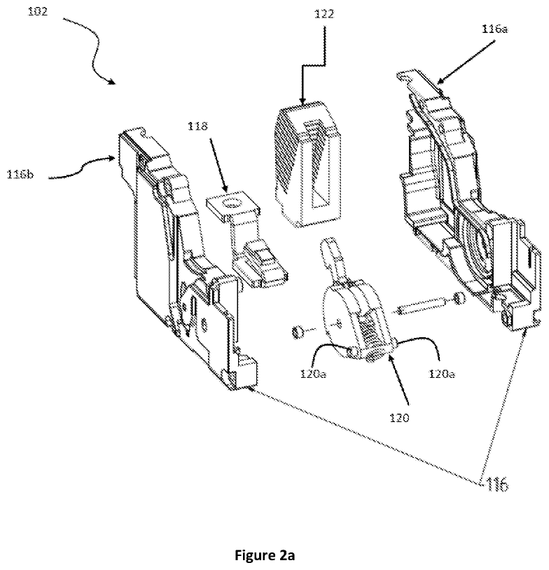

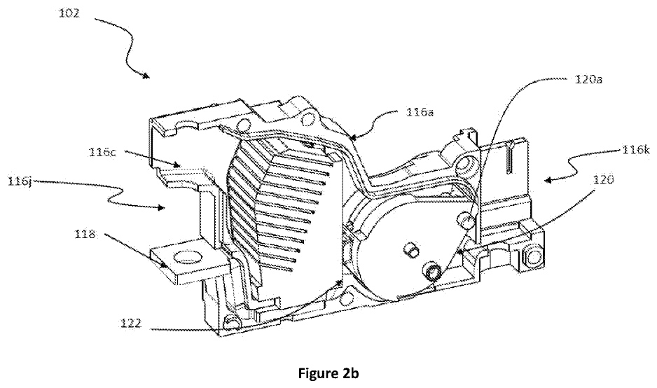

FIG. 2a shows an exploded view of one of the pole assemblies of the moulded case circuit breaker (MCCB) of FIG. 1b, in accordance with the concepts of the present disclosure.

FIG. 2b shows a perspective view of the one of the pole assemblies of the moulded case circuit breaker (MCCB) of FIG. 2a, illustrating internal components of the pole assembly, in accordance with the concepts of the present disclosure.

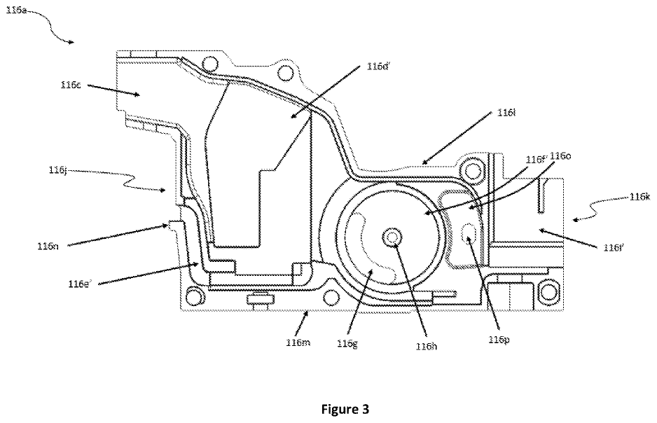

FIG. 3 shows an orthogonal left side view of a first cassette member of a cassette casing unit of the pole assembly of FIGS. 2a and 2b, in accordance with the present disclosure.

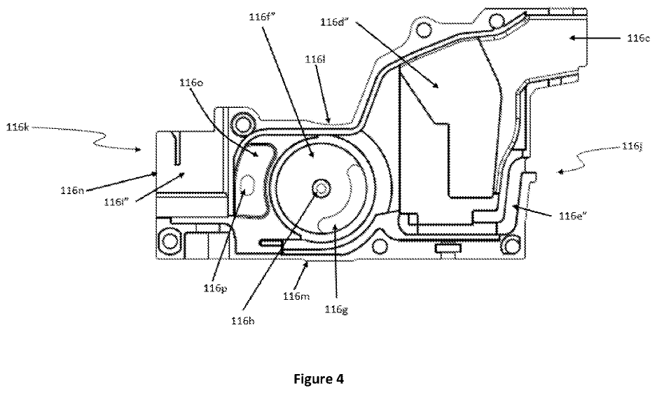

FIG. 4 shows an orthogonal right side view of a second cassette member of a cassette casing unit of the pole assembly of FIGS. 2a and 2b, in accordance with the present disclosure.

### DETAILED DESCRIPTION OF THE INVENTION

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only one of the problems discussed above. Some of the problems discussed above might not be fully addressed by any of the features described herein. Exemplified embodiments of the present invention are described below, as illustrated in various drawings in which like reference numerals refer to the same parts throughout the different drawings.

FIG. 1a shows an exploded view of a moulded case circuit breaker (MCCB) [100], in accordance with the concepts of the present disclosure. FIG. 1b shows an exploded view of an arrangement between three (3) pole assemblies [102], an actuator assembly [112], and a TRIP assembly [114] of the moulded case circuit breaker (MCCB) [100] of FIG. 1a, in accordance with the concepts of the present disclosure. Figures la and 1b should be referred to in conjunction with each other, in order to clearly understand the concepts of the present disclosure. The moulded case circuit breaker [100] is a low-voltage and high-current circuit breaker, employed to protect electrical networks/circuits from over-load or short-circuit conditions. The MCCB [100] is positioned between at least one load phase on a load side and at least one line phase on a line side, for providing protection during over-load or short-circuit conditions. The MCCB [100] operates between each of an ON position, an OFF position, and a TRIP position, wherein the MCCB [100] is manually adjusted between the ON position and the OFF position, whereas MCCB [100] is automatically adjusted to the TRIP position due to overloading or short-circuiting at the line side or the load side of the MCCB [100]. In the ‘ON’ position, the MCCB [100] allows a flow of current therethrough, whereas, in each of the ‘OFF’ position and the ‘TRIP’ position, the MCCB [100] restricts the flow of current therethrough.

Commonly, the MCCB [100] is a multipolar circuit breaker. Although, in the present disclosure the MCCB [100] is described as a three-pole circuit breaker, it may be obvious to a person skilled in the art that the MCCB [100] may also be a single-pole circuit breaker, a four-pole circuit breaker, or a circuit breaker with any number of poles. The MCCB [100] includes the three (3) pole assemblies [102], a base assembly [104], a mid-cover assembly [106], a fascia plate assembly [108], the actuator assembly [112], and the trip assembly [114].

Each of the three pole assemblies [102] are independent units capable of protecting the electrical networks/circuits from over-load or short-circuit conditions. In particular, each of the three pole assemblies [102] transmits electric current from one of the line phases to one of the load phases, while providing protection from overcurrent or short-circuit. Each of the three pole assemblies [102] operate in each of the ‘ON’ position, the ‘OFF’ position, and the ‘TRIP’ position. Notably, the three pole assemblies [102] are connected together with one or more components of the actuator assembly [112], to adjust each of the three pole assemblies [102] together between the ‘ON’ position, the ‘OFF’ position, and the ‘TRIP’ position. A structure and arrangement of the three pole assemblies [102] will be described later in details.

The base assembly [104] is a lower structure that provides a mounting base and support structure for holding and supporting each of the three pole assemblies [102] therein. In particular, the base assembly [104] defines pole holding cavities to mount and support each of the three pole assemblies [102] therein. Notably, the three pole assemblies [102] are fixedly attached within the pole holding cavities defined by the base assembly [104]. An attachment means for attaching the three pole assemblies [102] within the pole holding cavities defined by the base assembly [104] includes, such as but not limited to, a bolt attachment means, a screw attachment means, a rivet attachment means, an adhesive attachment means, a fit attachment means, a weld attachment means, and the like.

The mid-cover assembly [106] is an upper structure that is engaged with the base assembly [104], to at least partially cover the three pole assemblies [102] and protect the same from external environment and mounting of accessories. The mid-cover assembly [106] is usually fittingly engaged with the base assembly [104], to at least partially cover the three pole assemblies [102] and protect the same from external environment. Although, the mid-cover assembly [106] is described to be attached to the base assembly [104] by way of a fit attachment means, it may be obvious to a person skilled in the art that any other known attachment means may also be envisioned.

The fascia plate assembly [108] is fittingly mounted on the mid-cover assembly [106], to cover the mid-cover assembly [106]. The fascia plate assembly [108] defines portions to define electrical parameters related to MCCB [100].

The actuator assembly [112] is a multi-part component mounted on one of the pole assemblies [102]. The actuator assembly [112] connects the three pole assemblies [102] together, such that the three pole assemblies [102] are manually adjusted together between the ON position, the OFF position, and the TRIP position, by means of the actuator assembly. The actuator assembly [112] includes a lever that may be manually adjusted to adjust the three pole assemblies [102] together between the ON position, the OFF position, and the TRIP position. In particular, the lever of the actuator assembly [112] may be manually manipulated, to adjust the three pole assemblies [102] together from the ON position to the OFF position and vice versa. Moreover, one or more of the three pole assemblies [102] may be adjusted to the TRIP position, during overload or short-circuit conditions. Additionally, the TRIP assembly [114] is mounted on one of the three pole assemblies such that the TRIP assembly [114] triggers the actuator assembly [112] to adjust the three pole assemblies [102] together to the TRIP position. Further, the manually adjustable lever of the actuator assembly [112] may be manipulated to reset the three pole assemblies [102] together from the TRIP position to the OFF position.

The TRIP assembly [114] is mounted and supported on one of the three pole assemblies and is structured and arranged to connect the three (3) pole assemblies [102] together, such that the three (3) pole assemblies [102] are adjusted together from the ON position to the TRIP position. In particular, in the overload and/or short-circuit conditions of one of load phase or line phase of one of the three (3) pole assemblies [102], one or more of the three (3) pole assemblies [102] are adjusted to the TRIP position. Notably, one or more of the three (3) pole assemblies [102] can be removed from and/or attached to the MCCB [100], in order to operate the MCCB [100]. A structure and arrangement of one of the three (3) pole assemblies [102] will be described in detail hereinafter. Similar structure and arrangement of the remaining pole assemblies [102] may be envisioned. FIG. 2a shows an exploded view of the pole assembly [102] of the MCCB [100]. FIG. 2b shows a side view of the pole assembly of the MCCB [100]. FIG. 3 shows orthogonal left side view of a first cassette member [116a] of a cassette casing unit [116] of the pole assembly [102] of FIGS. 2a and 2b. FIG. 4 shows orthogonal right side view of a second cassette member [116b] of the cassette casing unit [116] of the pole assembly [102] of FIGS. 2a and 2b. FIGS. 2a, 2b, 3, and 4, should be referred to in conjunction with each other, to clearly understand the scope of the present disclosure. Although, the present disclosure is described as applied to the pole assembly [102] of single break contact type assembly, it may be obvious to a person skilled in the art that the concepts of the present disclosure may also extend to the pole assembly [102] of any numbers of break contact type assembly. The pole assembly [102] includes the cassette casing unit [116], a stationary contact unit [118], a rotary contact unit [120], and an arc chute unit [122]. Notably, the cassette casing unit [116] of each of a plurality of pole assemblies [102] comprised in the MCCB [100] is such that the plurality of pole assemblies [102] are arranged with each other, in a modular manner. More particularly, a number of the plurality of pole assemblies [102], in combination, define a number of electrical connection poles of the MCCB [100], such that one or more of the plurality of pole assemblies [102]0 can be removed and/or deployed, in order to vary the number of electrical connection poles of the MCCB [100].

The cassette casing unit [116] houses and supports each of the stationary contact unit [118], the rotary contact unit [120], and the arc chute unit [122] of the pole assembly [102]. Furthermore, the cassette casing unit also houses and supports at least a section of the trip assembly [114]. In particular, the pole assembly [102] defines various dedicated sections for housing and supporting each of the stationary contact unit [118], the rotary contact unit [120], and the arc chute unit [122] of the pole assembly [102], and at least a section of the trip assembly [114]. The cassette housing unit [116] is a two-part structure comprising the first cassette member [116a] and the second cassette member [116b] each of which can be fittingly attached together, while housing the stationary contact unit [118], the rotary contact unit [120], and the arc chute unit [122] therein. In particular, the first and second cassette members [116a, 116b], in combination, define at least partially enclosed structure defining a top face [116l], a bottom face [116m], a left face, a right face, and a front face [116n]. Notably, each of the first cassette member [116a] and the second cassette member [116b] are attached together, by means of an attachment means. The attachment means being one of a bolt attachment means, a screw attachment means, a snap fit attachment means, a rivet attachment means, and the like.

The first cassette member [116a] and the second cassette member [116b], in combination, defines an arc chute unit holding portion [116d], a stationary contact unit holding portion [116e], a rotary contact unit portion [116f], and a trip assembly holding portion [116i]. The arc chute unit holding portion [116d] is defined proximal to a front side [116j] thereof, for positioning the arc chute unit [122] therein. The stationary contact unit holding portion [116e] is defined below the arc chute unit holding portion [116d], for positioning the stationary contact unit [118] therein. The rotary contact unit holding portion [116f] is defined adjacent to the arc chute unit holding portion [116d], for positioning the rotary contact unit [120] therein. Whereas, the trip assembly portion [116i] is defined adjacent to the rotary contact unit portion [116f] and proximal to a rear side [116k] thereof, for positioning at least a section of the trip assembly [114]. Notably, the rotary contact unit holding portion [116f] includes a housing positioning depressed region [116o] and an extension guiding depressed region [116p].

In one embodiment, the first cassette member [116a] defines a first-half arc chute unit holding portion [116d′], a first-half stationary contact unit holding portion [116e′], a first-half rotary contact unit portion [116f′], and a first-half trip assembly holding portion [116i′]. Whereas, the second cassette member [116b] defines a second-half arc chute unit holding portion [116d“], a second-half stationary contact unit holding portion [116e”], a second-half rotary contact unit portion [116f′], and a second-half trip assembly holding portion [116i″]. Notably, each of the first-half arc chute unit portion [116d′], the first-half stationary contact unit holding portion [116e], the first-half rotary contact unit portion [116f], and the first-half trip assembly holding portion [116i], and the second-half arc chute unit holding portion [116d″], the second-half stationary contact unit holding portion [116e″], the second-half rotary contact unit portion [116f′], and the second-half trip assembly holding portion [116i″], in combination, define an arc chute unit holding portion [116d], a stationary contact unit holding portion [116e], a rotary contact unit portion [116f], and a trip assembly holding portion [116i], respectively. Preferably, each of the first-half arc chute unit portion [116d′], first-half stationary contact unit holding portion [116e], the first-half rotary contact unit portion [116f], the first-half trip assembly holding portion [116i], and the second-half arc chute unit holding portion [116d″], the second-half stationary contact unit holding portion [116e″], the second-half rotary contact unit portion [116f″], and the second-half trip assembly holding portion [116i″] may be provided in form of positioning grooves, for snug positioning of each of the arc chute unit [122], the stationary contact unit [118], the rotary contact unit [120], and the section of the trip assembly [114] therein, respectively. In an alternate embodiment, merely one of the first and second cassette members [116a, 116b] provides for an arc chute unit holding portion [116d], a stationary contact unit holding portion [116e], a rotary contact unit portion [116f], and a trip assembly holding portion [116i], while the other of the first and second cassette members [116a, 116b] may be a cover attached thereto. In the present disclosure, one of the housing positioning depressed region [116o] and the extension guiding depressed region [116p] is defined by the first-half rotary contact unit holding portion [116f′], while another of the housing positioning depressed region [116o] and the extension guiding depressed region [116p] is defined by the second-half rotary contact unit holding portion [116f″]. Furthermore, one extended portion [120a] of the rotary contact unit [120] extends within the extension guiding depressed region [116p] in the first-half rotary contact unit holding portion [116f′], while another extended portion [120a] of the rotary contact unit [120] extends within the extension guiding depressed region [116p] in the second-half rotary contact unit holding portion [116f″]. For ease in reference and understanding, an arrangement of one extended portion [120a] of the rotary contact unit [120] with the extension guiding depressed region [116p] in the first-half rotary contact unit holding portion [116f′] will be explained in details hereinafter, however, similar arrangement of the other extended portion [120a] of the rotary contact unit [120] with the extension guiding depressed region [116p] in the second-half rotary contact unit holding portion [116f″] may be contemplated.

The cassette casing unit [116] further defines a cantilever gas exhaust channel [116c] extending from the arc chute holding portion [116d] towards the front side [116j], and being fluidly communicating with environment. Notably, the cantilever gas exhaust channel [116c] has a uniform internal width between the first cassette member [116a] and the second cassette member [116b], for efficient vent of exhaust gases generated therein. The width of the cantilever gas exhaust channel is almost equal to the overall width of cassette assembly. Furthermore, each of the first and second cassette members [116a, 116b] of the cassette casing unit [116] further define a through-hole [116h] at the rotary contact unit holding portion [116f], that houses metal bushing [117] therein. The metal bushing [117] allows rotatable positioning of a rotary shaft of the rotary contact unit [120] onto the cassette casing unit [116]. The usage of the metal bushing [117] reduces the friction in the joint between the rotary contact unit [120] and the cassette casing unit [116], thereby increasing the rotational speed of the rotary contact unit [120] especially during over-load or short-circuit condition. Moreover, each of the first and second cassette members [116a, 116b] define a drive-shaft guiding slot [116g] at the rotary contact unit holding portion [116f] that allows a drive-shaft to pass through the rotary contact unit [120] of multiple adjacently positioned pole assemblies [102]. Furthermore, the top face [116l] of the cassette casing unit [116] defines a trip access opening above the trip assembly holding portion [116i], while the left face thereof defines the drive-shaft guiding slot [116g], and the top face [116l] defines a gas exhaust opening and a stationary contact access opening.

The stationary contact unit [118] is an electric contact plate structure that may be positioned within a defined portion in the cassette casing unit [116]. The stationary contact unit [118] is provided to connect to electrical wires from the line side. In particular, in complete assembly of the MCCB [100], the electrical wires from the line side are usually connected to the stationary contact unit [118].

The rotary contact unit [120] is a moving structure that engages/disengages with the stationary contact unit [118], to allow/restrict the flow of electric current therethrough. The rotary contact unit [120] is rotatably positioned within a defined portion in the cassette casing unit [116], and is provided to connect to electrical wires from the load side. In particular, in complete assembly of the MCCB [100], the electrical wires from the line side are usually connected to the stationary contact unit [118]. Further, the rotary contact unit [120] is rotatably adjusted while being positioned within the cassette casing unit [116], to make and release a contact relative to the stationary contact unit [118], in order to allow and restrict the flow of electric current therebetween, respectively. Notably, the rotary contact unit [120] ‘makes’ a contact relative to the stationary contact unit [118] to allow the flow of electric current (the ‘ON’ position), the rotary contact unit [120] ‘releases’ a contact relative to the stationary contact unit [118], to restrict the flow of electric current (the ‘OFF’ position). Additionally, the rotary contact unit [120] is adjusted without complete rotation, to release a contact relative to the stationary contact unit [118], to restrict the flow of electric current (the ‘TRIP’ position). The rotary contact unit is made up of rotary housing member, an elongated rotary arm, and a toggling mechanism, suitably arranged with each other to adjust the elongated rotary arm between the ON position, the OFF position, and the BLOW open position. Furthermore, the rotary housing member of the rotary contact unit [120] defines an extended portion [120a] extending horizontally outwards from the rotary housing member, such that the rotary housing member of the rotary contact unit [120] is position within housing positioning depressed region [116o] of the rotary contact unit holding portion [116f], while the extended portion [120a] of the rotary contact unit [120] extends within the extension guiding depressed region [116p] of the rotary contact unit holding portion [116f]. With such arrangement, the extended portion of the rotary contact unit [120] is guided within the extension guiding depressed region [116p] of the rotary contact unit holding portion [116f], as the MCCB is switched between the ON position and the OFF position by rotary movement of the rotary contact unit [120]. Particularly, such guiding of the extended portion of the rotary contact unit [120] within the extension guiding depressed region [116p] of the rotary contact unit holding portion [116f] corresponds to stable positioning of the rotary contact unit [120] at the ON position and the OFF position.

The arc chute unit [122] is positioned within the arc chute unit portion [116d] of the cassette casing unit [116] and comprises of a two-wall shaped arc chute holder member [122a] and an arc chute member [122b]. The arc chute holder member [122a] and an arc chute member [122b], are arranged together, to vent out gases generated by an arc caused due to engagement/disengagement of the rotary contact unit [120] relative to the stationary contact unit [118] through a vent channel. Various holes are also provided in the cassette casing unit to vent such gases from the pole assembly [102].

Various advantages of the presently disclosed cassette casing unit [116] are disclosed. For example, the cassette casing unit [116], as disclosed in present disclosure, has gas exhaust opening [116c] integrated therein. This reduces the need of placing an extra component adjacent to the cassette casing unit [116] for facilitating the disposal of exhaust gases generated within the cassette casing unit [116]; thereby reducing assembly time, cost and complexity and increasing compactness of the MCCB [100]. The cassette casing unit [116], as disclosed in present disclosure, defines position of each component of the pole assembly [102], such a particular layout that the overall assembly of the cassette casing unit [116] and the MCCB [100] is compact and simpler thereby further reducing assembly time, cost and complexity. Further, as the extended portion of the rotary contact unit [120] is guided within the extension guiding depressed region [116p] of the rotary contact unit holding portion [116f], while the MCCB is switched between the ON position and the OFF position by rotary movement of the rotary contact unit [120], there is a plastic-to-plastic contact while switching from the ON position to the OFF portion and vice versa, thereby resulting in low coefficient of restitution leading to elimination of any damping means and little to negligible deformation of parts.

While the preferred embodiments of the present invention have been described hereinabove, it should be understood that various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

### LIST OF COMPONENTS

100—Moulded case circuit breaker (MCCB)
102—Pole assembly
104—Base assembly
106—Mid-cover assembly
108—Fascia plate assembly
112—Actuator assembly
114—Trip assembly
116—Cassette casing unit
116a—First cassette member
116b—Second cassette member
116c—Cantilever gas exhaust channel
116d—Arc chute unit holding portion
116d′—First-half arc chute unit holding portion
116d″—Second-half arc chute unit holding portion
116e—Stationary contact unit holding portion
116e′—First-half stationary contact unit holding portion
116e″—Second-half stationary contact unit holding portion
116f—Rotary contact unit holding portion
116f—First-half rotary contact unit holding portion
116f″—Second-half rotary contact unit holding portion
116g—Drive-shaft guiding slot
116h—Through-hole
116i—Trip assembly holding portion
116i′—First-half trip assembly holding portion
116i″—Second-half trip assembly holding portion
116j—Front side of the cassette casing unit
116k—Rear side of the cassette casing unit
116l—Top face
116m—Bottom face
116n—Front face
116o—Housing positioning depressed region
116p—Extension guiding depressed region
118—Stationary contact unit
120—Rotary contact unit
120a—Extended portion
122—Arc chute unit
122a—Arc chute holder member
122b—Arc chute member

I/We claim:

1. A cassette casing unit [116] of a moulded case circuit breaker (MCCB) [100], the cassette casing unit [116] adapted to house and support a stationary contact unit [118], a rotary contact unit [120], and an arc chute unit [122] of a pole assembly [102] of the MCCB [100], therein, the cassette casing unit [116] comprising:
a first cassette member [116a]; and
a second cassette member [116b],
wherein a combination of the first cassette member [116a] and the second cassette member [116b] defines:
an arc chute unit holding portion [116d] defined proximal to a front side [116j] thereof, for positioning of the arc chute unit [122];
a stationary contact unit holding portion [116e] defined below the arc chute unit holding portion [116d], for positioning of the stationary contact unit [118];
a rotary contact unit holding portion [116f] defined adjacent to the arc chute unit holding portion [116d], for positioning of the rotary contact unit [120];
a trip assembly holding portion [116i] defined adjacent to the rotary contact unit holding portion [116f] and proximal to a rear side [116k] thereof, for positioning of at least a section of a trip assembly [114] of the MCCB [100]; and a cantilever gas exhaust channel [116c] extending from the arc chute holding portion [116d] towards the front side [116j], and being fluidly communicating with environment, wherein the cantilever gas exhaust channel [116c] has a uniform internal width between the first cassette member [116a] and the second cassette member [116b], for efficient vent of exhaust gases generated therein.

2. The cassette casing unit [116] as claimed in claim 1, wherein the first cassette member [116a] defines a first-half arc chute unit holding portion [116d′], a first-half stationary contact unit holding portion [116e′], a first-half rotary contact unit holding portion [116f′], and a first-half trip assembly holding portion [116i′], while the second cassette member [116b] defines a second-half arc chute unit holding portion [116d″], a second-half stationary contact unit holding portion [116e″], a second-half rotary contact unit holding portion [116f″], and a second-half trip assembly holding portion [116i″], to define in combination the arc chute unit holding portion [116d], the stationary contact unit holding portion [116e], the rotary contact unit holding portion [116f], and the trip assembly holding portion [116g], respectively.

3. The cassette casing unit [116] as claimed in claim 2, wherein each of the first-half arc chute unit holding portion [116d′], the first-half stationary contact unit holding portion [116e′], the first-half rotary contact unit holding portion [116f′], the first-half trip assembly holding portion [116i′], the second-half arc chute unit holding portion [116d″], the second-half stationary contact unit holding portion [116e″], the second-half rotary contact unit holding portion [116f′], and the second-half trip assembly holding portion [116i″] may be provided in form of positioning grooves for snug positioning of each of the arc chute unit [122], the stationary contact unit [118], the rotary contact unit [120], and the section of the trip assembly therein, respectively.

4. The cassette casing unit [116] as claimed in claim 1, wherein each of the first cassette member [116a] and the second cassette member [116b] further defines a through-hole [116h] at the rotary contact unit holding portion [116f] that houses metal bushings [117] therein, for allowing rotatable positioning of a rotary shaft of the rotary contact unit [120] onto the cassette casing unit [116].

5. The cassette casing unit [116] as claimed in claim 1, wherein the first cassette member [116a] and the second cassette member [116b] further defines a drive-shaft guiding slot [116] at the rotary contact unit holding portion [116f] that allows a drive-shaft to pass through the rotary contact unit [120] of multiple adjacently positioned pole assemblies [102].

6. The cassette casing unit [116] as claimed in claim 1, wherein the first cassette member [116a] and the second cassette member [116b] in combination, defines at least partially enclosed structure defining a top face [116l], a bottom face [116m], a left face, a right face, and a front face [116n].

7. The cassette casing unit [116] as claimed in claim 6, wherein the top face [116l] defines a trip access opening above the trip assembly holding portion [116g], the left face and the right face define a drive-shaft guiding slot, and the front face [116n] defines an exhaust gas opening and a stationary contact access opening.

8. The cassette casing unit [116] as claimed in claim 1, wherein each of the left cassette member [116a] and the right cassette casing member [116b] are attached together, by means of an attachment means.

9. A moulded case circuit breaker (MCCB) [100] comprising:
a plurality of pole assemblies [102], each of the plurality of pole assemblies [102] including:
the cassette casing unit [116] as claimed in claim 1;
the stationary contact unit [118];
the rotary contact unit [120]; and
the arc chute unit [122],
wherein each of the plurality of pole assemblies [102], are arranged with each other, in modular manner.

10. The MCCB [100] as claimed in claim 9, wherein a number of the plurality of pole assemblies [102], in combination, define a number of electrical connection poles of the MCCB [100], and wherein one or more of the plurality of pole assemblies [102] can be removed and/or deployed, in order to vary the number of electrical connection poles of the MCCB [100].

11. A cassette casing unit [116] of a moulded case circuit breaker (MCCB) [100], the cassette casing unit [116] adapted to house and support a stationary contact unit [118], a rotary contact unit [120], and an arc chute unit [122] of a pole assembly [102] of the MCCB [100], therein, the cassette casing unit [116] comprising:
a first cassette member [116a]; and
a second cassette member [116b],
wherein a combination of the first cassette member [116a] and the second cassette member [116b] defines:
an arc chute unit holding portion [116d] defined proximal to a front side [116j] thereof, for positioning of the arc chute unit [122];
a stationary contact unit holding portion [116e] defined below the arc chute unit holding portion [116d], for positioning of the stationary contact unit [118];
a rotary contact unit holding portion [116f] defined adjacent to the arc chute unit holding portion [116d], for positioning of the rotary contact unit [120]; and
a trip assembly holding portion [116i] defined adjacent to the rotary contact unit holding portion [116f] and proximal to a rear side [116k] thereof, for positioning of at least a section of a trip assembly [114] of the MCCB [100], wherein the rotary contact unit holding portion [116f] includes a housing positioning depressed region [116o] and an extension guiding depressed region [116p], such that a rotary housing member of the rotary contact unit [120] is position within housing positioning depressed region [116o], while an extended portion [120a] of the rotary contact unit [120] extends within the extension guiding depressed region [116p].

12. The cassette casing unit [116] as claimed in claim 11, the extended portion of the rotary contact unit [120] is guided within the extension guiding depressed region [116p] of the rotary contact unit holding portion [116f], as the MCCB [100] is switched between an ON position and an OFF position by rotary movement of the rotary contact unit [120].
